(19) United States
(12) Patent Application Publication
(10) Pub. No.: US 2015/0317729 A1
(43) Pub. Date: Nov. 5, 2015

(54) Financial Evaluation Based on Foreign Remittance Activity

(71) Applicant: Bank of America Corporation, Charlotte, NC (US)

(72) Inventors: Jo-Anne Rivet, Charlotte, NC (US); Elizabeth Faires, Gastonia, NC (US)

(21) Appl. No.: 14/799,825

(22) Filed: Jul. 15, 2015

Related U.S. Application Data
(63) Continuation of application No. 13/571,990, filed on Aug. 10, 2012, now abandoned.

(51) Int. Cl. G06Q 40/02; G06Q 40/00

(52) U.S. Cl. CPC G06Q 40/025; G06Q 40/12

(57) ABSTRACT

Methods, systems, computer readable media, and apparatuses for establishing and/or altering a consumer's payment performance assessment based on foreign remittance transactions are disclosed. A line of credit may be extended to customers for foreign remittance transactions. Customer information may be received and evaluated to determine whether to extend the line of credit to the customer. Numerical values may be assigned to one or more items of the customer information. If a total numerical value representing the customer information meets predetermined criteria, the line of credit is extended to the customer. The customer's foreign remittance transactions may be monitored and reported to one or more consumer agencies to establish and/or alter the consumer's payment performance assessment.

### CROSS-REFERENCE TO RELATED APPLICATIONS

This application claims the benefit of and is a continuation of U.S. patent application Ser. No. 13/571,990, filed Aug. 10, 2012, and entitled “Financial Evaluation Based on Foreign Remittance Activity,” which is incorporated by reference herein in its entirety.

### TECHNICAL FIELD

One or more aspects of the disclosure generally relate to computing devices, computing systems, and computer software. In particular, one or more aspects of the disclosure generally relate to computing devices, computing systems, and computer software that may be used by an organization, such as a financial institution, or other entity to monitor a customer's foreign remittances in order to establish a consumer's payment performance or alter an existing credit assessment.

### BACKGROUND

Consumers in the United States often send remittances or payments for goods and services to individuals located in foreign countries. Currently, a consumer's payment performance does not include or take into account foreign remittance data.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

The statistical model related to a consumer's payment performance developed by the Fair Isaac Corporation (“FICO”) is based on a consumer's U.S. payment history, amounts of money owed to others, length of payment performance, new payment performance data, and types of financial instruments used. Remittance histories can help assess and/or predict a consumer's payment performance, by establishing payment history. Thus, adding such data to credit files may produce a change in the credit assessment for some foreign remittance senders. Additionally, the addition of foreign remittance data to a consumer's credit file can provide credit assessments for consumers who do not have an established payment performance. Aspects of this disclosure are directed to establishing a consumer's payment performance and/or altering a credit assessment based on foreign remittance transactions of a consumer.

Aspects of the disclosure relate to methods, computer-readable media, and apparatuses for monitoring a customer's foreign remittance transactions and establishing a consumer's payment performance and/or altering the consumer's credit assessment based on foreign remittance transactions. For example, a business, such as a financial institution may extend a line of credit to a consumer to allow them to lock in a specific conversion or exchange rate for foreign remittances, or payments to a foreign country, at one or more specified times in the future. The line of credit may be established to cover the expected or normal market movement in that currency. For example the currency in Country X may require a 2% line of credit whereas the currency in Country Y may require a 1% line of credit. These values are hypothetical numbers for illustrative purposes only and may have no relation to the actual requirements. The customer may provide information, such as his or her name, address, assets, and work history. According to one or more aspects of the disclosure, the customer may pledge collateral in exchange for the line of credit. The business may evaluate the customer information and based on the customer information, determine whether to extend the line of credit to the customer for the foreign remittances. Components or items within the customer information may be assigned numerical values, which are combined and totaled to determine if a numerical value representing the customer information is above a predetermined threshold. If the numerical value representing the customer information is above a predetermined threshold, the line of credit may not be extended to the customer. Alternatively, if the numerical value representing the customer information is below the predetermined threshold, the line of credit may be extended to the customer. After extending a line of credit to the customer, the business may monitor the foreign remittance transactions over a period of time and report the customer's foreign remittance transaction history to one or more credit agencies.

According to one or more additional aspects of the disclosure, the business may generate a contract with the customer that memorializes the customer's agreement to purchase a set amount of foreign currency for one or more remittances in the future. The contract may specify a currency rate for the remittances. The currency rate may be based on the exchange rate between the two countries at the time the contract was generated.

In one or more embodiments, the evaluation of the customer information may take into account any established credit history for the customer, the assets held by the customer, the collateral pledged by the customer in exchange for the line of credit, and/or the change in the exchange rate over the life of the contract. Additionally or alternatively, the evaluation of the customer information may take into account the amount of the foreign remittances and/or the customer's work history.

In one or more embodiments, the customer may establish a payment performance or alter an existing credit assessment with the business based on the foreign remittance transactions. Additionally or alternatively, the customer may establish a payment performance or alter an existing credit assessment with one or more credit agencies based on the foreign remittance transactions. The customer's payment performance may be positively or negatively affected by the foreign remittance transactions. For example, if the customer follows through on the committed payments, has the funds available for the foreign remittances when they are due, and the foreign remittances are sent on time, the credit assessment may be positively affected. Alternatively, if the customer does not have the funds available at the time the foreign remittances are due or does not honor the terms of the contract, the customer's credit assessment may be negatively affected.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented.

FIG. 1B illustrates another example operating environment in which various aspects of the disclosure may be implemented.

FIG. 2 illustrates an example method of establishing or altering a consumer's payment performance based on foreign remittance transactions.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made, without departing from the scope of the present disclosure.

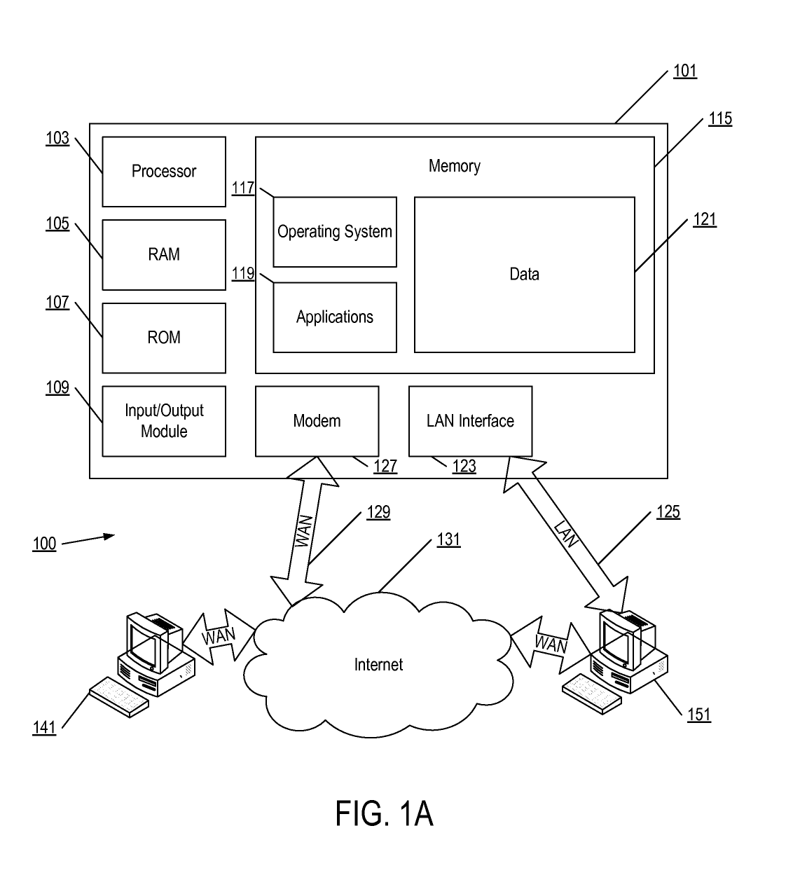

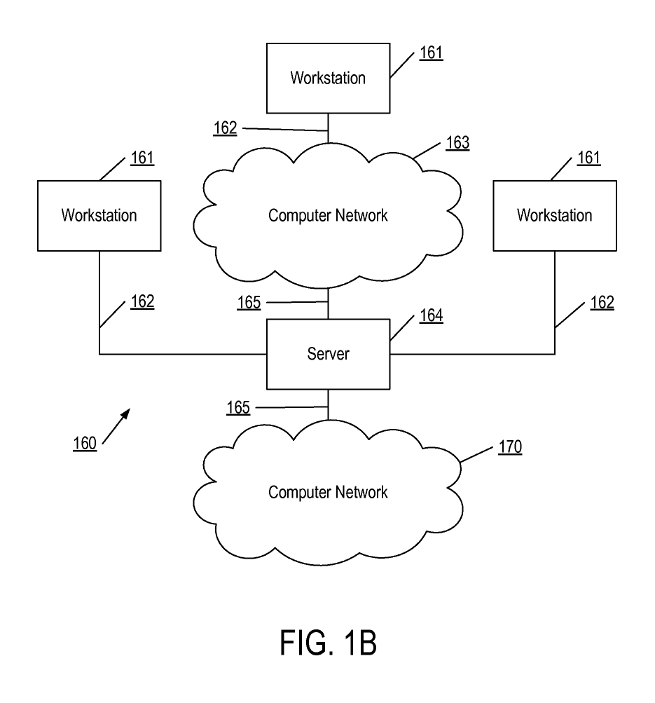

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed. Generic computing device 101 and/or terminals 141 or 151 may also be mobile terminals (e.g., mobile phones, smartphones, PDAs, notebooks, and the like) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and the like.

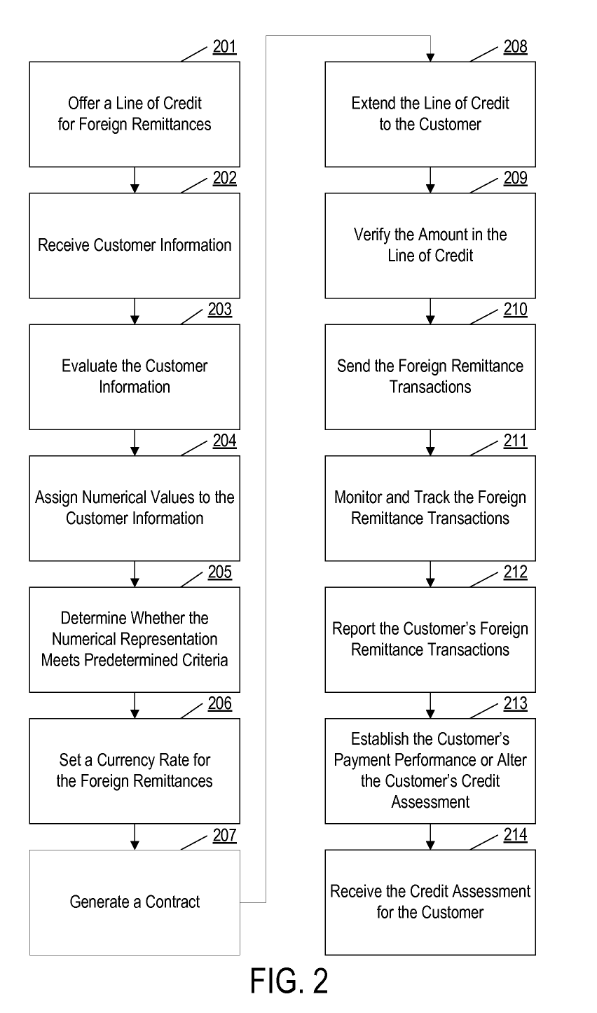

FIG. 2 illustrates an example method of evaluating customer information, and establishing a consumer's payment performance and/or altering a credit assessment based on a history of foreign remittance payments, according to one or more illustrative aspects described herein. According to one or more aspects, any and/or all of the methods described herein may be implemented by software executed on one or more computers, such as the generic computing device 101 of FIG. 1A, and/or by a computing system, such as system 160 of FIG. 1B. In some arrangements, the methods described herein may be performed by and/or in combination with a server (e.g., server 164). Additionally or alternatively, the methods described herein may be performed by and/or in combination with one or more workstations (e.g., workstations 161).

As illustrated in step 201, a business, such as a financial institution, may offer a line of credit to a customer to make remittance payments to a foreign country in the future. The line of credit may be established to cover the potential movement of the currency over the time frame when the customer has committed to make these remittances. This may be necessary if the currency involved was to lose value, because the remitter may choose not to follow through with the contract, thinking they could receive a better rate. The line of credit may be offered in any manner. For example, the line of credit may be offered to customers through advertisements, such as on the website of a financial institution or may be offered to a customer that visits the financial institution. The foreign remittances may be for any type of payment. For example, the foreign remittances may be for recurring payments, such as rent or utility bills in a foreign country. Alternatively, the foreign remittances may be for recurring payments to an individual in a foreign country. The line of credit may be extended to any customer, such as a new customer or an existing customer. Additionally, the line of credit may be extended to a customer with an established credit history or a customer without an established credit history and who does not make regular payments to a financial institution for items such as a mortgage, credit card, or car payment.

In step 202, the financial institution may receive information from the customer applying for the line of credit. The information received from a customer may be any type of information, for example, the information may include the amount of credit requested, the customer's name, social security number, current and past address, current and past work history, bank account information, the names and addresses of the potential payees, and the expected payments and dates of the payments. The information may also include information about the customer's assets or collateral that the customer will pledge in return for the line of credit. The customer information may be received in any manner. For example, the customer may fill out an application for the line of credit through a website or at a workstation, such as workstation 161 at a financial institution. Alternatively, a customer service representative may receive the user's information over the phone or in person and enter the customer information into a form or a database on a server at the financial institution.

In step 203, the customer's information is evaluated to determine whether or not to extend a line of credit to the customer. Any additional factors, such as the type of currency and the standard movement in the market may be evaluated at this step along with the customer information. A line of credit might not be extended, e.g., when the customer does not honor his or her commitment to purchase a specific amount and type of currency at a specific rate in the future. In this step, any portion of the customer information may be evaluated to determine whether or not to extend the line of credit to the customer. For example, the amount of the remittances, the number of remittances, the type of assets a customer has, the type and/or amount of collateral pledged, the length of the work history, any history with the financial institution, and/or any prior credit assessments or credit history may be evaluated. The customer information may be evaluated in any manner. For example, the customer information may be evaluated by a processing device. Alternatively, the customer information may be evaluated by a person.

To determine whether to extend the line of credit to the customer, as illustrated in step 204, numerical values may be assigned to one or more items of the customer information. The numerical values may then be combined and totaled to provide a numerical value representative of the evaluation of the customer information. Any numerical value may be given to the one or more items of the customer information. For example, a numerical value of 1, 5, 10, 100, and the like, may be applied to customer information, such as established credit history, a credit assessment, the amount of the payment, and/or an amount of pledged collateral. The combined numerical values may be combined using any desired formula.

In step 205, the processor determines whether the numerical value representing the combined customer information meets predefined criteria. In at least one embodiment, the predefined criteria is a predetermined threshold. For example, if the numerical value representing the combined customer information exceeds the predetermined threshold, the line of credit might not be extended to the customer. In at least one embodiment, if the numerical value representing the combined customer information exceeds the predetermined threshold, the application for the line of credit is routed to a customer service representative to manually review the customer's information and determine whether to extend a line of credit to the customer. Alternatively, if the numerical value representing the combined customer information exceeds the predetermined threshold, or a specific limit, the customer may be denied the line of credit. If the numerical value representing the combined customer information is below the predetermined threshold, the processor determines a specific currency rate for the future foreign remittances, as illustrated in step 206. The currency rate chosen may be based on the current exchange range between the countries. Additionally or alternatively, the exchange rate may take into account the length of the contract and/or the historical movement or change in the exchange rate between the two countries.

In step 207, a contract may be generated with the customer to memorialize the customer's commitment to purchase a specific amount of foreign currency at one or more specific times in the future for one or more remittances. The customer may commit to any number of foreign remittances. For example, the customer may commit to a single foreign remittance, or may commit to one or more remittances each month for a period of time, such as six months or a year. The contract may be generated by a processor and sent electronically to the customer. In step 208, the line of credit may be extended to the customer for future foreign remittances. In this step, the contract exists for the future payments, but the customer's account is not debited until a specified time in the future, e.g. when the remittance is scheduled. As illustrated in step 209, the processor may verify the funds in the customer's account prior to paying the foreign remittance. When the foreign remittance is scheduled or due, the customer's account is debited, and the beneficiary is paid, as illustrated in step 210. The beneficiary of the foreign remittance may be paid automatically by the financial institution on the due date. Alternatively, the customer may send the currency to the beneficiary on the due date. The currency may be sent to the beneficiary in any form, such as a draft or wire. The form of the currency may depend on what type of form the financial institution offers for a specific currency.

In step 211, the customer's remittance transactions are monitored and tracked by the financial institution. Any type of information regarding the remittance transactions may be monitored and tracked. For example, the financial institution may track the customer's identity, the customer's account balance at the time of the foreign remittances, the number of remittances that were sent, the beneficiaries of the remittances, the amount of the remittances, and the duration of the line of credit.

In step 212, the customer's remittance transactions are reported to one or more credit agencies. Any type of information may be sent to the credit agencies. For example, the credit agencies may be sent the customer's identity, the number of foreign remittances paid by the customer, the type of foreign remittances, the amount of the foreign remittances, the duration of the line of credit, the number of foreign remittances to each party and/or whether the customer fulfilled his or her commitment to make a specific number of foreign remittances at a specific currency rate.

In step 213, based on the foreign remittance history with the financial institution, the customer may establish a credit history or alter his or her credit history with the financial institution. A customer's credit history may be positively or negatively affected by the foreign remittance transactions. For example, if the customer honors his or her commitment to purchase a specific amount of foreign currency at a specific rate in the future, has the funds available for the foreign remittances when they are due, and the foreign remittances are sent on time, the credit history may be positively affected. Alternatively, if the customer does not have the funds available at the time the remittances are due or does not honor his or her commitment to purchase the specific amount of currency at a time in the future, the customer's credit history may be negatively affected. Additionally or alternatively, the customer may establish a payment performance or alter his or her credit assessment with one or more credit agencies based on the customer's foreign remittance transaction history. For example, the credit agencies may include the foreign remittance data in their categories of payment history, length of credit history, new credit, and types of credit used.

Additionally, as illustrated in step 214, the financial institution may receive a credit assessment for the customer from a credit agency. The credit assessment may be based at least partially on the foreign remittance history. In at least one embodiment, the customer may not have previously had a credit assessment established. In an alternative embodiment, the customer may already have an established credit assessment that was altered due to the remittance history. A customer's credit assessment may be positively or negatively affected due to the customer's foreign remittance transaction history.

As an illustrative example, a financial institution advertises a line of credit for foreign remittances on its website. A customer, through a website, fills out an application for the line of credit. The customer provides information such as his or her identity, his or her address, his or her place of work, his or her annual income, the length of time that the customer has been employed with his or her current employer, a desired number of foreign remittances, the desired amount of each of the foreign remittances, and an amount of collateral the customer may pledge in exchange for the line of credit. In this example, the customer wants to send a reoccurring amount to Country X for the next six months. The financial institution determines whether to extend the line of credit to the customer. In this example, a processor within the financial institution extracts the customer's information from the application and evaluates the customer information. The processor then evaluates whether the customer has established history with the financial institution, the credit assessment of the customer, the amount of collateral pledged, the amount of the remittances, and the historical market movement in the exchange rate of Country X. To determine whether or not to extend the line of credit, the processor assigns a numerical value to one or more items provided in the customer information.

In this example, the processor within the financial institution assigns a numerical value of 10 to each of the credit assessment and the established history because the customer has not established a history with the financial institution and does not have an established payment performance. The processor assigns a numerical value of 1 to the amount of collateral pledged because the amount of the collateral is close to the total amount of the remittances over the six months. The processor assigns a numerical value of 1 to the amount of the foreign remittances because the total amount of the foreign remittances requested is low. The processor assigns the numerical value of 5 to the historical market movement in the exchange rate of Country X. The processor determines the total combined numerical value that represents the evaluated customer information, which in this example, is 27. The processor determines whether the numerical value representing the customer information is less than a predetermined threshold value. In this example, the predetermined threshold is 50. Because the numerical value representing the customer information is less than the predetermined threshold, the processor determines that the financial institution will extend a line of credit to the customer.

The processor determines a currency rate for the future six months of foreign remittances. The processor chooses the current exchange rate between the two countries. The processor generates a contract between the customer and the financial institution and sends the contract to the customer. The customer signs the agreement and sends it back to the financial institution. Once the contract is agreed to, the line of credit is extended to the customer. The customer sets up a reoccurring payment for an amount of ## each month to Beneficiary Y. Prior to a foreign remittance being paid, a processor within the financial institution checks the customer's account and verifies that the customer has the required funds to send to Beneficiary Y. The customer has the necessary funds in his or her account, so the processor sends a check to Beneficiary Y. This process is repeated for each of the six months. At the end of the six months, the customer has fulfilled his or her contract with the financial institution and the financial institution sends a report to one or more credit agencies with the customer's identity, the amount of the foreign remittances, and that the customer paid the remittances on time for each of the six months. In this example, the credit agencies take the customer's remittance history into account and establish a credit assessment for the customer. The credit agencies report the credit assessment back to the financial institution upon request from the financial institution.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A system, comprising:
at least one processor;
at least one network interface; and
memory storing computer-readable instructions that, when executed by the at least one processor, cause the system to:
receive, via the at least one network interface, customer information;
evaluate the customer information;
assign a numerical value to one or more items in the received customer information;
calculate a total numerical value representing the customer information; and
in response to determining that the total numerical value representing the customer information meets predefined criteria:
cause a line of credit to be extended to the customer for a set number of foreign remittance transactions over a specified period of time;
monitor the customer's foreign remittance transactions over the specified period of time; and
report the customer's foreign remittance transaction history to one or more credit agencies.

2. The system of claim 1, wherein the customer's foreign remittance transaction history is reported to the one or more credit agencies at the end of the specified period of time.

3. The system of claim 1, wherein the memory stores additional computer-readable instructions that, when executed by the at least one processor, further cause the system to:
set a foreign currency rate for the line of credit extended to the customer for the set number of foreign remittance transactions over the specified period of time.

4. The system of claim 1, wherein evaluating the customer information comprises evaluating an amount of the foreign remittance transactions.

5. The system of claim 4, wherein evaluating the customer information further comprises evaluating assets held by the customer.

6. The system of claim 4, wherein evaluating the customer information further comprises evaluating collateral pledged by the customer.

7. The system of claim 1, wherein the set number of foreign remittance transactions are to one or more individuals in a foreign country.

8. The system of claim 1, wherein the memory stores additional computer-readable instructions that, when executed by the at least one processor, further cause the system to:
receive a credit assessment for the customer based at least in part on the customer's foreign remittance transaction history.

9. A method, comprising:
receiving, by a computing device comprising at least one processor and at least one network interface, via the at least one network interface, customer information;
evaluating, by the computing device, the customer information;
assigning, by the computing device, a numerical value to one or more items in the received customer information;
calculating, by the computing device, a total numerical value representing the customer information; and
in response to determining that the total numerical value representing the customer information meets predefined criteria:
setting, by the computing device, a foreign currency rate for a line of credit to the customer for a set number of foreign remittance transactions over a specified period of time;
causing, by the computing device, the line of credit to be extended to the customer;
monitoring, by the computing device, the customer's foreign remittance transactions over the specified period of time; and
reporting, by the computing device, the customer's foreign remittance transaction history to one or more credit agencies.

10. The method of claim 9, wherein evaluating the customer information comprises evaluating an amount of the foreign remittance transactions.

11. The method of claim 10, wherein evaluating the customer information further comprises evaluating assets held by the customer.

12. The method of claim 10, wherein evaluating the customer information further comprises evaluating collateral pledged by the customer.

13. The method of claim 9, wherein reporting the customer's foreign remittance transaction history comprises reporting the set number of foreign remittance transactions, an amount of each of the set number foreign remittance transactions, and the specified period of time.

14. The method of claim 13, further comprising:
receiving, by the computing device, a credit assessment for the customer based at least in part on the customer's foreign remittance transaction history.

15. The method of claim 9, wherein monitoring the customer's foreign remittance transactions over the specified period of time comprises tracking the customer's account balance at a time of each transaction of the foreign remittance transactions, tracking a number of remittances that are sent, tracking one or more beneficiaries of each transaction of the foreign remittance transactions, and tracking an amount of each transaction of the foreign remittance transactions.

16. The method of claim 9, wherein reporting the customer's foreign remittance transaction history to the one or more credit agencies comprises providing, to the one or more credit agencies, information indicating whether the customer fulfilled a commitment to make the set number of foreign remittance transactions at the set foreign currency rate.

17. At least one non-transitory computer-readable medium having computer-executable instructions stored thereon that, when executed by a computing comprising at least one processor and at least one network interface, cause the computing device to:
receive, via the at least one network interface, customer information;
evaluate the customer information;
assign a numerical value to one or more items in the received customer information;
calculate a total numerical value representing the customer information; and
in response to determining that the total numerical value representing the customer information meets predefined criteria:
cause a line of credit to be extended to the customer in accordance with a contract for a set number of foreign remittance transactions over a specified period of time;
monitor the customer's foreign remittance transactions over the specified period of time; and
report the customer's foreign remittance transaction history to one or more credit agencies.

18. The at least one non-transitory computer-readable medium of claim 17, wherein the customer information comprises the customer's name, address, and location of employment.

19. The at least one non-transitory computer-readable medium of claim 17, wherein the set number of foreign remittance transactions are to a plurality of individuals in one or more foreign countries.

20. The at least one non-transitory computer-readable medium of claim 17, wherein the contract comprises one or more foreign currency rates for the foreign remittance transactions.
